(19) United States
(12) Patent Application Publication
(10) Pub. No.: US 2011/0271822 A1
(43) Pub. Date: Nov. 10, 2011

(54) Automatic Real Time Command and Control System

(75) Inventor: DAVID MYR, Jerusalem (IL)

(73) Assignee: MAKOR ISSUES AND RIGHTS LTD., Jerusalem (IL)

(21) Appl. No.: 13/009,864

(22) Filed: Jan. 20, 2011

(30) Foreign Application Priority Data
May 4, 2010 (IL) 205526

(51) Int. Cl. F41H 13/00

(52) U.S. Cl. 89/1.11

(57) ABSTRACT

A system and method are provided for Unit of Action (UA) real-time optimal Command and Control (C²), where the UA's mission is to defeat the enemy in a predefined geographical zone. Command and Control (C²) functions are performed through an arrangement of personnel, equipment, communications, facilities, and procedures employed by a commander in planning, directing, coordinating, and controlling UA forces and operations in the accomplishment of the mission. The situation in the battlefield is continuously and rapidly changing thus it requires fast reaction from the Command and Control to optimally manage the battle, taking into consideration multitude factors which affect the decision.

Structurally, a UA may include one or more units, such as Signal Companies, Intelligence Companies, mobile gun System Companies, Infantry Companies (INF), non-line-of-sight battalion (NLOS), Air Force manned and unmanned units, Navy units.

The disclosed system takes into consideration, the characteristics of the friendly UA weapon systems, the characteristics of the enemy's weapons and targets, as well as the battle space environment parameters such as weather and terrain (using Digital Elevation Model—DEM).

Initially, the system optimally allocates the UA forces and thereafter continuously sends optimal sequence of Move and Shoot commands to all the weapon units.

The system continuously provides a forecast of the combat status at a selected future time, or it can provide combat completion time estimate as requested by the operator.

Optimization is achieved by solving multi-object functions subject to constraints using known programming techniques.

### FIELD OF INVENTION

The present invention relates generally to military combat Command and Control (C²). More specifically, the present invention enables optimal combat planning and performs real time, optimal and adaptive C² in the fast changing battlefield environment.

### BACKGROUND OF INVENTION

Military operations can be classified by the scale and scope of force employment. A military engagement is a combat between two forces in which each has an assigned or perceived mission. The size of the forces involved is between a company and a division. As a tactical mission the engagement is often part of a battle, and usually lasts for no more than five days.

The engagement commander is supported by C² functions which are performed through an arrangement of personnel, equipment, communications, facilities and procedures employed by a commander in planning, directing, coordinating, and controlling Unit of Action (UA) forces and operations in the accomplishment of the mission. The battlefield is continuously and rapidly changing. Therefore it requires fast reaction from the C² to optimally manage the battle, taking into consideration multitude factors which affect the decision. In analyzing the combat situation and issue new commands, multitude of parameters and variables must be taken into consideration. There are many possible courses of action that can be taken, from which the optimal one must be selected. This selection is usually based on the commander's training, intuition and experience. Suffice is to say that in order to allocate n friendly weapon units to m enemy targets, one weapon per target, the number of combinations is given by:

$$Number of Combinations = min ( m , n ) ! ( \begin{matrix}max ( m , n ) \\ \vert m - n \vert\end{matrix} ) !$$

When both n and m equal 10 then there are more than 3.6 million allocation combinations. Thus, an automatic system that can, in real time, select the optimal course of action is highly desired.

Much work has been done on C² systems. Stuart Kauffman, in a patent application, suggested a system for adaptive and robust command and control using technology graphs, in which operation sequences are identified. Essays were written on decision support systems for the commanding officer. Much work has been done on optimizing the force structure for acquisition purposes, such as in U.S. Pat. No. 7,367,542 “system method and computer program for modeling a force structure” by H. Reuttel and R Cline.

The United States Army's Command Post of the Future (CPOF) is a C² software system that allows commanders to maintain top sight over the battlefield, collaborate with superiors, peers and subordinates over live data and communicate their intent. The purpose of this effort is to double the speed and quality of command decisions.

The Maneuver Control System serves as a mission critical C² that allows commanders and staffs to visualize the battle space and synchronize the elements of combat power for successful execution of combat operations.

The assumption underlying the currently developed C² systems is that decisions made by the commander in the C² center are conveyed along the command chain, where each level of command interprets it and derives a more specific command to the next level. The final shoot command is given by the lowermost command level. We, in the invention, provide a system and a method which automatically, in real time makes optimal command decisions, and directly issues sequence of commands to individual weapon units, while providing the commander valuable information on the current battle situation as well as forecast for the future.

### SUMMARY OF THE INVENTION

The need in the art is addressed by the system and method for automatic, real-time optimal C² of the present invention. The inventive method includes the steps of combat planning followed by real time battle management. The present invention generates and transmits to each and every friendly WU a sequence of shoot and move commands based on the simulation of the battle. The command sequence is continuously updated. Between two consecutive command sequences updates, called Sequence Period, the system simulates the battle either till the end conditions' as specified by the operator, are met or a predefined number of simulation cycles or time limit. A command sequence is comprised of a simulation sequence in which multiple simulation cycles are performed and one pair of Shoot-Move optimization with the most updated received data.

During the planning phase data is collected on the Weapon Classes (WC) participating in the battle space of both friendly forces and enemy forces, followed by simulation of battle scenarios for various environmental conditions and for variety of combinations of WC and Weapon Units (WU), from which combat plans and initial allocation of WU are derived. This planning process is continuously executed, taking into consideration updated information on WC and WU, so that an updated initial combat plans and WU's allocation is always available.

During the real-time battle management phase, the system prepares, for each WU belonging to the friendly forces, a sequence of optimal move and shoots commands and sends these commands directly to each WU. The information in the system is continuously updated, via a communication network, on the actual battlefield situation. The data is obtained from multitude sensors such as intelligence sensors which monitor the enemy and automatic and/or manual operated equipment from the friendly forces. The system reacts in real time to the new situation, and prepares and emanates an updated sequence of move and shoots commands to the WU.

In addition to the preparation of immediate commands to be sent to the weapon units, the system simulates, based on the current situation, the future development of the battle, and thus provides valuable forecast on the expected evolution of the battle and provides timely alert on the need for additional forces allocation.

The system transfers move and shoot sequence of commands directly to each and every WU, thus shortening the time from the decision taking to execution of that command. It relieves the weapon unit operator, regardless if it is human operated or robotic operated equipment, from the need to make decisions which are based on its own situation analysis. It also enables the efficient use of Non Line Of Sight (NLOS) WC.

The system uses all available information on the WU in the battlefield, the topography of the battle zone, as well as combat parameters determined by its operator, such as maximum risk for the friendly units, engagement end conditions etc. Real time information is obtained from intelligence equipment on the enemy, and from automatic reporting from the friendly forces. All the data is fed into three multi-objective optimization models. The first one is an Allocation model, the output of which is used by the Shoot model which feeds information into the Move model. The combat parameters are evaluated during the planning phase by performing Monte Carlo simulations using randomly selected set of parameters for each simulation run and monitoring the results.

### BRIEF DESCRIPTION OF THE DRAWINGS

FIG. 1 is an organization chart of an embodiment of typical Unit of Action (UA) in which the current invention can be integrated.

FIG. 2 is a block diagram showing the structure of one embodiment of the system.

FIG. 3 presents top level flowchart showing the system modes of operation.

FIG. 4 is a flowchart of one simulation sequence.

FIG. 5 is a flowchart explaining one simulation cycle.

FIG. 6 contains a flowchart that presents the flow of control and the processing done in the battle planning mode of operation.

FIG. 7 is a flowchart that describes the system operation in real time battle command and control mode of operation.

FIG. 8 is a diagram that describes the timing of the system operation.

### DETAILED DESCRIPTION

### General

The present invention will now be described more fully hereinafter with reference to the accompanying drawings, in which preferred embodiment of the invention is shown. The invention may, however, be embodied in many different forms and should not be construed as limited to the embodiment set forth herein; rather this embodiment is provided so that the disclosure will be thorough and complete, and will fully convey the scope of the invention to those skilled in the art.

The disclosed system models a combat between two armed forces, referenced to hereafter as Green Unit of Action (GUA)—representing the friendly forces, and Blue Unit of Action (BUA)—which represents the Enemy forces. The BUA forces are located a defined geographical region.

### Force Structure

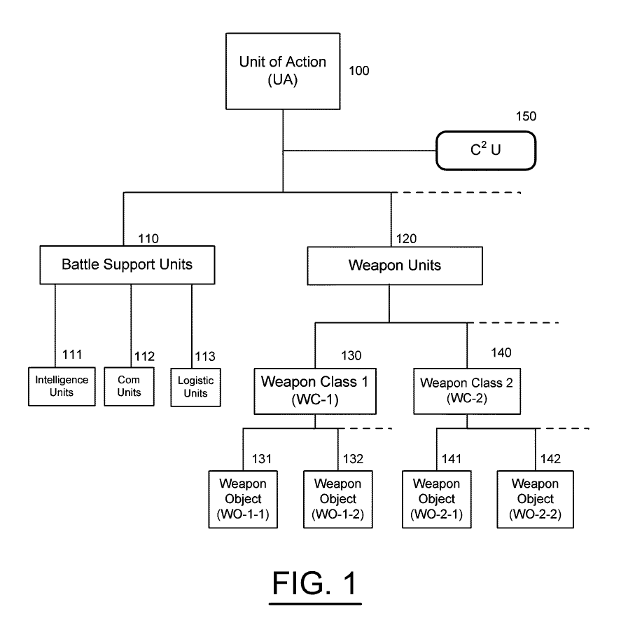

FIG. 1 shows the structure of a UA (100) as modeled in the invention. The UA is comprised of Weapon Units (120) and Battle Support Units (110). The Weapon Units are comprised of plurality of Weapon Classes (WC), such as WC-1 (130), WC-2 (140). From each WC there are pluralities of Weapon Objects (WO), such as WO-1-1 (131), WO-1-2 (132), WO-2-1 (141), WO-2-2 (142). It is important to note that a WC is an abstract entity, which defines the characteristics of a real WO. For example, a specific model of a tank constitutes a WC. Thus all the tanks in the force (WO) having the same characteristics belong to the same WC, but each tank has also private parameters such as location, number of shells, remaining fuel, activity status etc.

The Battle Support Units (110) are comprised of plurality of Intelligence Units—IU (111), Communication Units—CU (112) and Logistic Units—LU (113). The operation of all units is coordinated by a Command and Control Unit—C²U (150).

The CU provides two way secure fast data communication between the C²U and all other units. The IU operates plurality of equipment for gathering relevant data, in real time, on enemy units and digitally transmits it to the C²U. The data includes, as a minimum, the enemy's unit's class, location and status. The LU stores and provides consumables and support maintenance to all friendly units.

The disclosed system is used by the C²U of the GUA.

### System Architecture

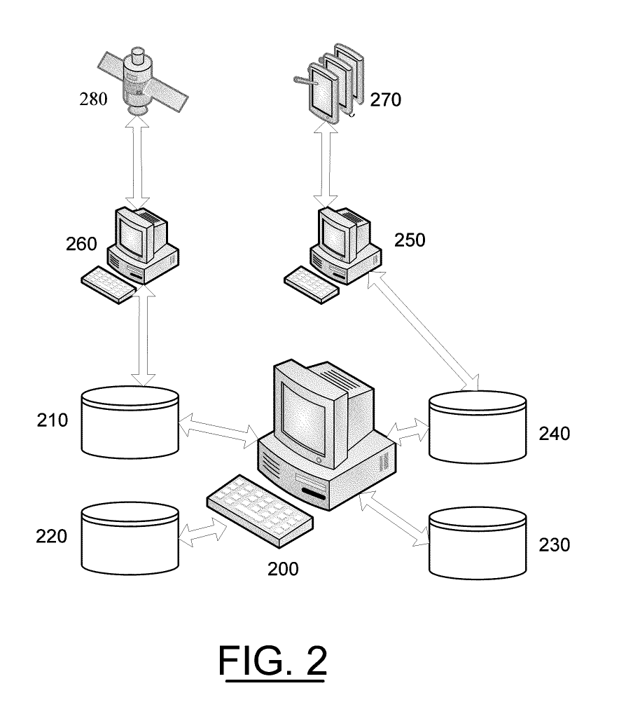

FIG. 2 is an example of the structure of one embodiment the invented system. The system is comprised of a Central Command Processor—CCP (200), operatively connected to 4 database engines each of which can be updated manually or automatically.

Performance characteristics of each and every Weapon Class (WC) in the arsenal of the Enemy BUA and the Friendly GUA, as well as data on static Enemy Targets are stored in the Weapon Characteristics Data Base—WCDB (220). The data in this database is updated whenever new information regarding the weapons is obtained. The information in this database includes, as a minimum for each WC, its mobility, lethality, survivability, sustainability, and deployability.

Geographic information on the battlefield is stored in the GIS Data Base—GISDB (230) which is operatively connected to the CCP (200), and which contains, as a minimum, data on the topography of the area as well as on obstacles such as barricades, minefields etc. This data is updated either via the CCP (200) or manually whenever new information is available.

Dynamic intelligence information on the Enemy WO is kept in the Intelligence Data Base—IDB (210). This database is operatively connected to the CCP (200) and to the Intelligence Computer—IC (260). It keeps updated information on the Enemy WO and theirs Battle Support Units, as to their current position, motion direction, status (whether it is still active) etc. This data is constantly updated by the IC (260) which gets its information from plurality of Intelligence Sensors—IS (280), which are operatively connected to the IC (260). It is the responsibility of the IU within the GUA to update the information in the IDB (210).

All the information obtained from the Friendly Units (GUA) as well as all command decisions obtained by the CCP are kept in the GUADB (240) which is operatively connected to the CCP and to the Communication Computer—CC (250). The CC updates the information in the data base using information obtained via variety of communication equipment, from the GUA, operating plurality of Friendly Communication Terminals GOCT-(270). Each Friendly WO transmits information on its location, on its logistic status as well as information on execution of the commands it received. The GOCT receives and display (in case of man operated WO), via the communication channels, the commands generated by the CCP (200).

The Intelligence Sensors—IS (280) can be comprised of high resolution cameras, radar systems including Synthetic Aperture Radar (SAR), Inverse SAR, sound sensitive sensors as well as any type of system capable of delivering the required information. The IS are operatively connected to the IC.

It is important to note that each unit within the GUA is equipped with navigation equipment that can automatically transmit its location. It is also possible for the GUA to have intelligence collection equipment, such as ikeGPS, which sends the information via communication channels and the communication computer (250), to the GUADB (240).

It is important to note that the described architecture presents one embodiment of the system.

It is important to note that it is assumed that all position, intelligence sensors and the GIS share the same coordinate system.

### MODES OF OPERATION

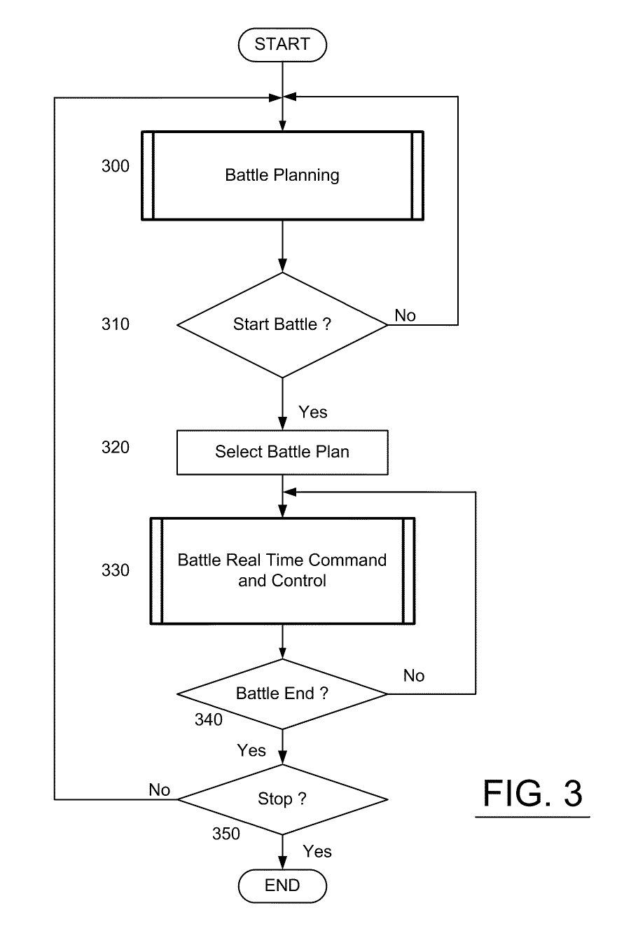

FIG. 3 is a flowchart that illustrates the modes of operation of the described system. The system has two modes of operation, which are the Battle Planning and Battle Real Time Command and Control.

In step 300 the system executes one cycle of battle planning at the end of which it checks, in step 310, whether to terminate the planning phase or to proceed with another planning cycle. Planning phase is terminated when the Battle Real Time Command and Control is selected.

The purpose of the planning phase is to enable the commanders to prepare battle plans for variety of scenarios and test alternative courses of action. The commander can define a set of parameters which are used as constrains in the optimization which are performed during the battle simulation. In the following paragraphs detailed description on the planning phase will be presented.

Once the battle begins the operator, in step 320 selects appropriate Battle Plan and in step 330 the system manages the battle till it is instructed to finish the real time management, in step 340. Upon exiting the Real Time Battle Command and Control the system, if not turned off in step 350, returns to operate in Planning Mode.

During Real Time Battle Command and Control the system uses real time information obtained from the battlefield via intelligence sources and from the GUA. In the following paragraphs detailed explanation on the real time battle management planning will be presented.

### Simulation Sequence

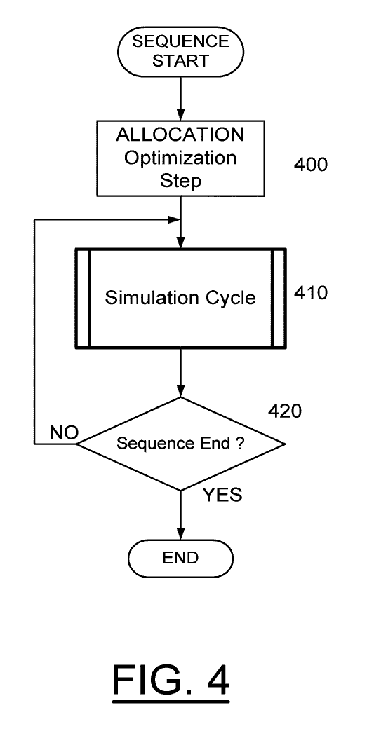

In the heart of the system there is a battle simulation engine which is described hereafter. The simulation engine uses multi-objective optimization models as well as Monte Carlo runs. Flowchart of a basic simulation sequence is shown in FIG. 4.

A simulation sequence consists of one allocation optimization, step 400, followed by multiple simulation cycles, step 410. The output of Allocation Optimization Step 400, which is carried out only for the friendly forces (GUA), is an optimal allocation and disposition of GUA with which to begin the battle. This optimization, as will be detailed later on, is based on given information on the both GUA and BUA units and on parameters specified by the operator.

Using the allocated forces assigned for the battle, a set of consecutive simulation cycles 410 are executed. The number of simulation cycles in a simulation sequence is a parameter defined by the system user. It can be defined either as a constant number, a value that represents time or as a condition which marks the end of the battle (such as enemy losses are greater than a predefined percentage). When the termination conditions, checked in step 420, are met, the simulation sequence terminates.

### Simulation Cycle

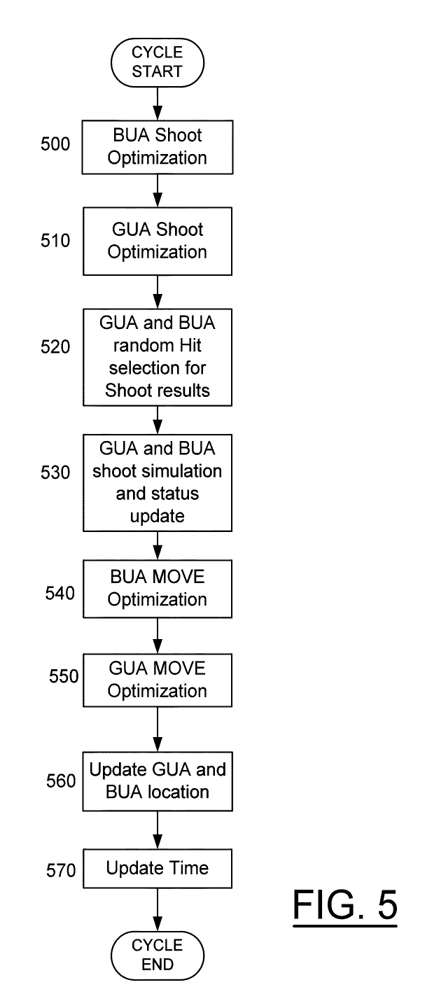

FIG. 5 presents a flowchart of a simulation cycle. It begins with optimization of the simulated shoot commands to be executed by the enemy forces BUA and the shoot optimization for the friendly forces GUA, steps 500 and 510 respectively. The output of each shoot optimization step is a simulated shoot command issued to each WO. In step 520 random hit parameters are selected in order to predict the outcome of the issued simulated shoot command, i.e. Monte Carlo shoot result simulation can be performed. In step 530 the status of the BUA and GUA WO are updated, i.e. those that were hit are marked and are taken out from the active weapon arsenal of both forces. In steps 540 and 550 move optimization is done for both forces taken into consideration the forces remained after the execution of the shoot command. The new location of the forces is updated in step 560 and in step 570 the simulation time is updated.

### Battle Planning Mode

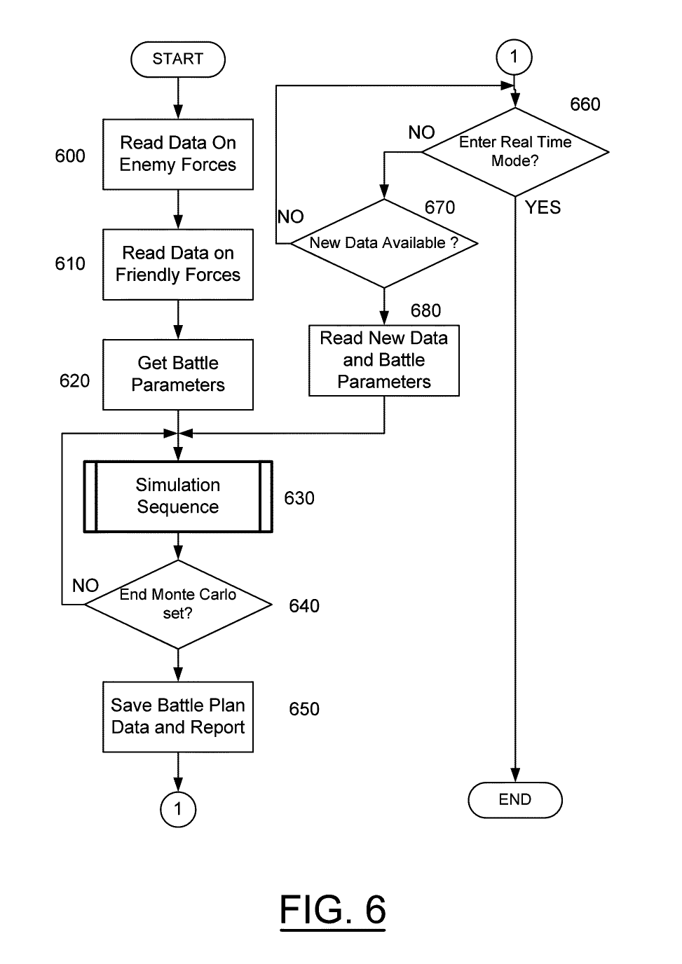

In FIG. 6 a flowchart of the planning mode of operation is given. At the beginning all the data on the enemy forces—BUA and the friendly forces—GUA are read from the relevant databases, in steps 600 and 610 respectively. After that, in step 620, the system gets battle parameters from the operator. These parameters define boundary conditions and constraints for the simulation and the optimization, such as budget limit, maximum sequence cycles, battle time limit or battle end conditions, maximum allowed risk to GUA units etc. When all data is ready the system performs multiple Simulation Sequences, step 630, as specified to obtain meaningful Monte Carlo simulation results, as checked in step 640. The results of the battle as well as its initial parameters are saved for future evaluation, step 650. If the system remains in planning mode, as checked in step 660, and new data or parameters are available, step 670, the new information is read, step 680, and another simulation sequence is launched. It is worth noting that for the evaluation of various plans, sets of parameters and data can be prepared, and in this case automatically, i.e. new data is available without waiting for manual inputs.

### Battle Real Time Command and Control

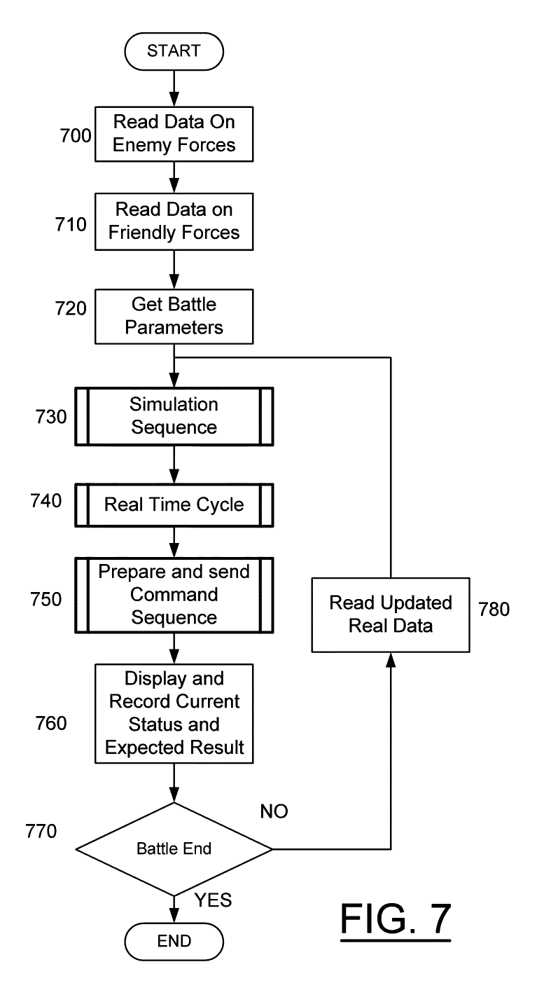

FIG. 7 is a flowchart of the processing done in the system when it operates in Real Time Command and Control mode. It starts with reading from the databases the data gathered on the enemy and friendly forces and getting the parameters of the battle plan to be used, as shown in steps 700, 710 and 720 respectively. At this stage the system repeatedly performs four consecutive steps which constitute the Control Cycle. The first of which is a simulation sequence, step 730, as described in detail in FIG. 4. This is followed by one real time cycle, step 740, after which, in step 750 command sequence is being prepared and transmitted to the friendly forces. The status of the battle is recorded and displayed to the commanders, step 760, who can intervene by modifying battle parameters. If the battle is still going on, as tested in step 770, then due to the activities of the forces involved, the situation in the real battlefield changes, thus new data is gathered by the intelligence units and obtained from the participating forces, so that another Control Cycle is initiated after reading the updated information, step 780.

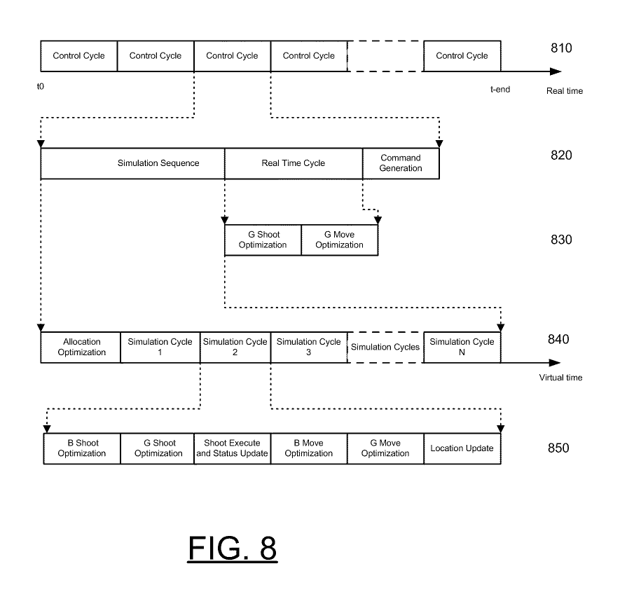

In FIG. 8 the timing of the system operation is shown. The system repeatedly executes a Control Cycle, as shown in 810, where the x axis represents real time. Typically processing of a Control Cycles takes between 1 and 3 minutes. During one Control Cycle, as shown in 820, the system performs a Simulation Sequence, a Real Time Cycle and finally generates commands that are distributed to the relevant units. In a Simulation Sequence, as shown in 840, the system executes one Allocation Optimization followed by multiple simulation cycles that are executed in order to predict the outcome of the battle. The Allocation is performed only for the enemy units which are left after the completion of the previous Simulation Sequence. As shown in 850 during each Simulation Cycle Shoot optimization is done for both the enemy and friendly forces (BUA and GUA) after which both sides shoot and the status of the relevant WO is updated. This is followed by optimization of Move of both forces and update of the WO location. As presented in 830, during the Real Time Cycle Shoot Optimization and Move Optimization are carried out only for the friendly forces. It is important to note that during the Shoot Optimization, the updated location of each friendly WO is used in order to prevent accidental shooting on friendly forces.

### Allocation Step—Detailed Description

In this simulation step optimal allocation and disposition of Weapon Objects Belonging to Green Unit of Action is accomplished. The multi-objective optimization performed in this step maximizes the damage inflicted upon the Blue Unit of Action (BUA) while minimizing the risk to the Green Unit of Action (GUA) and the risk to Green targets. The allocation is done from the available weapon arsenal, as defined in the weapon database (220, FIG. 2). To simplify the disposition we limit the number of angles from which a weapon or target can be attacked. These angles, which are randomly selected, are with respect to the Line Of Sight (LOS) between the attacking weapon and the attacked one. In the described embodiment, four angles of attack are implemented, which allows optimizing the initial positioning of the Green Weapon Objects (GWO) in order to achieve the optimization goals. The number of angles used is a parameter defined by the user. This number may be either a constant or a randomly selected integer ≧1 for each enemy target.

In the following paragraphs, detailed explanation of the inputs to this simulation step, it's processing, i.e. the cost/objective/target functions, the constraints and its output are described. It is worth noting that in the described embodiment, the optimization is solved by using Linear Programming technique but without the use of the time consuming MIP (Mixed Integer Programming). However, other optimization techniques may be used as long as no degradation in the real time performance of the system is observed.

### Allocation Step Inputs

The following notation is being used in the explanation of the allocation processing.

Let GᵢεG; i=1, 2, . . . , |G| denote Weapon Classes belonging to the Green Forces (GWC) and BⱼεB; j=1, 2, . . . , |B| denote Weapon Classes belonging to the Blue Forces (BWC). Information on the battle characteristics of every Weapon Class (WC) is kept in the database. It comprises WC motion capability in various environmental conditions (speed, passability), firing ranges and their effectiveness as a function of range, probability of neutralizing specific WC at tested ranges, traveling range/time between refueling, ammunition quantity, transportation means and cost etc. Thus Gᵢ and Bⱼ; represent Weapon Classes. The Weapon Objects (WO) are real weapons, each of which inherits its characteristics from a Weapon Class (WC), and has specific physical parameters as location, status etc.

There are Qᵢ^{G} Weapon Objects (WO) from each Gᵢ Weapon Class and Qⱼ^{B} Weapon Objects from each Bⱼ Weapon Class, which are denoted as gₘⁱ and bₙ^{j} respectively, where gₘⁱεGᵢ, m=1 . . . Qᵢ^{G} and bₙ^{j}εBⱼ, n=1 . . . Qⱼ^{B}. The position of gₘⁱ WO is (Xₘ^{i,G}, Yₘ^{i,G}, Zₘ^{i,G}) and that of bₙ^{j} WO is (Xₙ^{j,B}, Yₙ^{j,B}, Zₙ^{j,B}) In order to limit the computation complexity and thus its real time performance, we limit the number of attack directions for a specific bₙ^{j} to Kₙ^{j}, which is a parameter that can be defined for the system.

Since the allocation optimization takes into consideration the UA readiness time, i.e. the time it takes to organize and equip the Weapon Classes and position them in the battlefield, transportation issues are also addressed. There are Weapon Classes which can move to the battlefield independently and others that can either move by themselves or can be transported onboard a ground carrier, be air lifted etc. Therefore, data on a WC includes transport related information such as alternative Transportation Means, Transportation Speed per transportation mean, Transportation Cost per transportation mean, etc. It is assumed that a WO cannot shoot while being transported. However, a command to terminate transport can be issued. This command is executes as soon as the conditions allows it. Thus, in case of a ground or helicopter transported Weapon Type (WT), the response may be fast, but if the WT is on board a transport aircraft, the carrier has to land, and this can be done only in appropriate landing areas. Each Gᵢ WC can be transported by Lᵢ transportation means.

In addition to Weapon Class independent parameters there are cross Weapon Class parameters which define the probability that a Weapon class Gᵢ can destroy Weapon Class Bⱼ from a tested distance of Rᵢ^{j,G}. We denote this probability as aᵢ^{j}. Similarly we denote by βᵢ^{j} the probability that a WC Bⱼ can destroy a WC Gᵢ from a distance Rⱼ^{i,B}. From this data we derive the hit probability for different ranges as follows:

If r_{i,j,k} denotes the LOS distance from WC Gᵢ to WC Bⱼ for attack angle of γₖ then the probability of hitting Bⱼ by Gᵢ is computed by the equation:

pᵢ^{j,G}(r_{i,j,k})=aᵢ^{j}(Rᵢ^{j,G}/r_{i,j,k})².

Similarly, the probability of hitting Gᵢ by Bⱼ is computed by the equation:

pᵢ^{j,B}(r_{i,j,k})=βᵢ^{j}(Rⱼ^{i,B}/r_{j,i,k})² and where pᵢ^{j,G}(r_{j,i,k}),pᵢ^{j,B}(r_{j,i,k})<1.

In addition to the above mentioned parameters, price tags are attached to each Gᵢ and Bⱼ Weapon Classes, to its ammunition and operating cost. Price tag is also specified for each potential friendly target that may be destroyed by bₙ^{j} WO.

The initial coordinates from where Weapon Class Gᵢ can hit Weapon Object bₙ^{j} are computed by the following equation:

m_{n,k}=(Xₙ^{j,B}+Rᵢ^{G} cos γ_{k.}Rᵢ^{G} sin γₖ) for k=0,1, . . . Kₙ^{j}−1.

The attack angle γₖ can be specified by the battle planer or can be randomly selected by the system.

The equations given above refer to planar coordinate system. However, to take into consideration height differences and other topographical conditions, digital elevation model (DEM) is used. In DEM there are special codes for variety of topographical and conditions (mountains, sea, forest, etc.) for every cell of the territory. It is worth noting that the coordinates are computed only for those angles from which shooting are not blocked by the topographic conditions. It is important to note that at this simulation step few Gᵢ Weapon Classes can be allocated to a specific bₙ^{j} Weapon Object. Also, at this stage, initial position will be determined for all gₘⁱ Weapon Objects whereas only subset of bₙ^{j} Weapon Objects is being attacked. Hence, this is not the final GWO allocation and thus no commands are generated

### Decision Variables

The output of the allocation optimization is the assignment of specific GWO (gₘⁱ) to a specific BWO (bₙ^{j}) and determine the attack angle. It is important to note that due to the special structure of the objective function and constraints, decision variables are computed using standard linear programming technique without using time consuming MIP (Mixed Integer Programming) technique. Model's decision variables are denoted as X_{i,j,k,l}. These variables are binary and X_{i,j,k,l}=1 if a Weapon Class Gᵢ is assigned to a specific BWO (bₙ^{j}) (belonging to Weapon Class Bⱼ), with attack angle k and using transportation mean lεLᵢ, Otherwise X_{i,j,k,l}=0.

### Multi-Objective Function

Optimal allocations are those that cause maximum damage to Blue Unit of Action (BUA) while keeping to minimum the damage caused to Green Unit of Action and to the Green Targets (GUA+GT). To quantify the damage, a price tag is attached to each Weapon Class and to each Target.

Let us denote by D_{i,j,k}^{G} the damage caused to Weapon Object bₙ^{j} from Weapon Class Gᵢ positioned in direction k to the attacked unit. Let us denote by R_{i,j,k}^{G} the risk to Green Weapon Class Gᵢ from all bₙ^{j} Weapon Objects. Then, the cost function, which we want to maximize, is given by the expression:

$${\sum }_{l = 1}^{{L}_{i}} {\sum }_{i = 1}^{\vert G \vert} {\sum }_{j = 1}^{\vert B \vert} {\sum }_{k = 1}^{K} {X}_{i , j , k , l} ( {D}_{i , j , k}^{G} - {R}_{i , j , k}^{G} ) / {T}_{i , j , k , l}^{G} \qquad ( 1 )$$

D_{i,j,k}^{G} expresses the direct damage to the attacked Weapon Object plus the prevented damage—the risk—to G Weapon Objects and G Targets that the attacked Weapon Object can cause.

T_{i,j,k,l}^{G} represents the transportation time of the WT i.e. the time to get to the initial allocated position location mf_{i,j,k}^{G} from the base Gᵢ, using transportation mean 1εLᵢ

We are looking for a solution that maximizes the total difference between the damage and the risk with preference to minimal time factor. D_{i,j,k}^{G} is computed by the equation:

D_{i,j,k}^{G}=pⱼ^{i,G}(r_{i,j,k})[Cⱼ^{B}+Damageⱼ^{B}]

Where Cⱼ^{B} represents the cost of Blue Weapon Class j and Damageⱼ^{B} represents the expected prevented damage that Blue Weapon Class j can cause to all Green Targets. This prevented risk is evaluated by the equation:

$${Damage}_{j}^{B} = {\sum }_{j = 1}^{\vert B \vert} {\sum }_{i = 1}^{\vert G \vert + \vert C \vert} {\sum }_{k = 1}^{K} {p}_{i}^{j , B} ( {r}_{n , i , k}^{j} ) {C}_{i}^{G}$$

### Where:

Cᵢ^{G} represents the cost of Green Target i.
r_{n,i,k}^{j} is the 3 dimension distance from point m_{i,n,k}^{G} on the circumference with a radius Rᵢ^{G} around WO bₙεB at direction k to bⱼεB. In case there is an obstacle between bⱼεB and m_{i,n,k}^{G} that prevents shooting on the target then pᵢ^{j,B}(r_{n,i,k})=0.

The value of the risk is the product of the Weapon Object Cost and the probability of hitting it, thus:

R_{i,j,k}^{G}=Cᵢ^{G}*PR_{i,j,k}^{G}; where

$${PR}_{i , j , k}^{G} = 1 - {\prod }_{1 \leq n \leq \vert B \vert} [ 1 - {p}_{i}^{n , B} ( {r}_{i , j , k}^{n} ) ]$$

The above optimization is done under the following constraints:
a. Only one GWU—aₘⁱ—can be positioned in an optimal location with respect to a specific target.
b. Only those aₘⁱ WU that can be positioned in the optimal location within a specified time frame will be allocated to the battle. If we denote by Tₘⁱ the time to move aₘⁱ to its required initial location and by Tₘₐₓ⁰ the maximum time delay to the beginning of the battle, then the constraint is:

Tₘⁱ≦Tₘₐₓ⁰.
c. Allocation can be done only from the available arsenal i.e. no more than Mᵢ units from each Weapon Type Aᵢ expressed as:

$${\sum }_{l = 1}^{L} {\sum }_{j = 1}^{N} {\sum }_{k = 0}^{K} {X}_{i , j , k , l} \leq {M}_{i}$$

d. Allocation is done only if the damage to the enemy is greater than a predefined threshold—i.e.: minDamage

$${\sum }_{i = 1}^{\vert G \vert} {\sum }_{j = 1}^{\vert B \vert} {\sum }_{k = 1}^{K} {\sum }_{l = 1}^{L} {X}_{i , j , k , l} {D}_{i , j , k}^{G} \geq min Damage$$

No element is allocated if its faces a risk greater than a predefined threshold maxRisk_{A} i.e.

R_{n,k}^{m}≦maxRisk_{A} where:

R_{n,k}^{m} is the risk at m_{i,j,k}^{G}.
e. The total monetary cost of the allocated units must be within the limit of allocated budget C_{Total}^{G}. If we denote the monetary cost of unit belonging to WT as Cᵢ^{G} and the transportation cost as Cᵢ^{T}, then the constraint is:

$${\sum }_{l = 0}^{L} {\sum }_{j = 1}^{B} {\sum }_{k = 0}^{K} {\sum }_{i = 1}^{\vert G \vert} {X}_{i , j , k , l} ( {C}_{i}^{G} + {C}_{i}^{T} ) \leq {C}_{Total}^{G}$$

### Output

After objective function and constraints had been formulated, the linear program model is solved. Certain Green Weapon Objects (GWO) will be assigned to such attacking positions (due to objective function and subject to constraints above) from which they will cause maximal damage to Blue Unit of Action units when the battle starts, while being under minimal possible risk themselves.

Model's output is a set of decision variables, as defined above.

### Shoot Step—Detailed Description

### Shoot Model

The shoot model and the move model constitute the models executed during the simulation phase. These two models are sequentially evaluated with the relevant data in order to provide intelligent estimation on the expected results of the battle, from which immediate decisions can be made.

The available Green Weapon Objects (GWO) are those that were allocated at the beginning of the battle minus those that were neutralizes during the battle plus additional GWO that are added to the battle when required.

It is important to note that during the preparation phase, pure simulation is done, i.e. data on the location of GWO and BWO is obtained from simulation, whereas during real time battle management updated information on GWO and BWO is obtained from real sensors such as GPS, ikeGPS, SAR(I-SAR), Imaging Equipment etc.

GWO are expected to continuously report their location, by using their navigation equipment. Location of BWO is continuously obtained from the intelligence equipment allocated to the mission.

The information needed to execute the shoot optimization is available in the system data bases.

### Decision Variables

The decision variables are of binary nature. X_{m,n}^{S}=1, when BWO bₙ is attacked by GWO gₘ, whose location is m. Otherwise X_{m,n}^{S}=0. It is possible that two GWO will be assigned to attack the same BWO. This can occur if the value of BWO is high, and it justifies the allocation of more than one GWO to destroy it. In this case the decision variable is denoted as X_{m1,m2,n} which equals 1 if two GWO located at m1 and m2 are assigned to shoot BWO bₙ.

### Multi Objective Function

The Objective Function to be maximized is:

$${\sum }_{m = 1}^{\vert M \vert} {\sum }_{j = 1}^{\vert B \vert} {X}_{m , n}^{S} ( {D}_{m , j}^{G} - {ϕ}_{m}^{Alloc} ) \qquad ( s \text{-} 1 )$$

where φₘ^{Alloc} is the expected damage to BWU from GWO gₘ obtained from the allocation optimization. The purpose of this summand is to prevent the use of an allocated weapon resource (GWO) against low valued BWO. The value of D_{m,j}^{G} is computed using equation S-2 as follows:

D_{m,j}^{G}=Cⱼ^{B,T}pⱼ^{m,G}(rⱼ^{m}) and (s-2)

Cⱼ^{B,T}=Cⱼ^{B}+Cⱼ^{B,D} (s-3)

Cⱼ^{B} is the inventory cost of BWC Bⱼ and Cⱼ^{B,D} represents the expected total risk to all GWO from BWO bⱼ, i.e

$${C}_{j}^{B , D} = {\sum }_{m = 1}^{\vert G \vert} {Damage}_{j , m}^{B}$$

### Constraints

The above optimization is solved under the following constraints, which are inserted in order to reduce the required computation power, so it can be done in real time.
1. A Blue Weapon Object (BWO) is assigned as a target only if the probability of hitting it from the attacking GBO is bigger than a predetermined value—F_{Hit}.
2. At most one BWO is assigned to each GWO, i.e.

$${\sum }_{n = 1}^{\vert B \vert} {X}_{m , n}^{S} \leq 1 , m = 1 , 2 , … , \vert G \vert$$

At this stage, before a shoot command is generated, the system checks if any friendly Weapon Object may be hit by the shooting Weapon Object, in which case the shoot command is blocked. The computation takes into consideration the blast radii for each WC and its Circular Error Probability (CEP), which are stored in the database.

It is important to note that, for simulation purposes, after the shoot commands are generated, the shooting is executed, and as a result the status of Weapon Objects has changed. Thus, for the next simulation cycle, the value of Cⱼ^{B,T} is updated as follows:

Cⱼ^{B,T}(new)=Cⱼ^{B,T}(old)(1−pⱼ^{m,G}(rⱼ^{m}))

### Move Step—Detailed Description

### Move Model

In this simulation step a new location for each Green Weapon Object (GWO) is evaluated and a proper command is issued. The optimization is performed for the active GWO.

It is important to note that during the preparation phase, pure simulation is done, i.e. data on the location of GWO and BWO is obtained from simulation, whereas during real time battle management updated information on GWO and BWO is obtained from real sensors such as GPS, ikeGPS, SAR(I-SAR), Imaging Equipment etc.

GWO are expected to continuously report their location, by using their navigation equipment. Location of BWO is continuously obtained from the intelligence equipment allocated to the mission.

The information needed to execute the move optimization is available in the system data bases.

There are two move optimization models, one is applied to the active Weapon Objects, those that have shooting capability, and the other is applied to the logistic units. Hereunder we shall refer to each model.

### Model for Active Weapon Objects

### Decision Variables

The decision variables are of binary nature. X_{m1,m2}^{M}=1 when GWO gᵢ, currently located at m₁, is expected to move from location m1 to location m2. Otherwise X_{m1,m2}^{M}=0.

### Multi Objective Function

The Objective Function to be maximized is:

$${\sum }_{m 1 = 1}^{\vert M 1 \vert} {\sum }_{m 2 = 1}^{\vert M 2 \vert} {X}_{m 1 , m 2}^{M} ( {D}_{m 1 , m 2}^{G} - {R}_{m 1 , m 2}^{G} ) / {T}_{m 1 , m 2}^{G} \qquad ( m \text{-} 1 )$$

where D_{m1,m2}^{G} is the damage to BWO caused by GWO. The value of D_{m1,m2}^{G} is computed using equation m-2 as follows:

$${D}_{m 1 , m 2}^{G} = {\sum }_{j = 1}^{\vert B \vert} {C}_{j}^{B} {p}_{j}^{m 1} ( {r}_{j}^{m 2} ) \qquad ( m \text{-} 2 )$$

where pⱼ^{m1}(rⱼ^{m2}) is the probability that BWO bⱼ will be hit by GWO currently positioned in m1 when it gets to position m2.
R_{m1,m2}^{G} is the risk to GWO given by equation m-3:

R_{m1,m2}^{G}=Cₘ₁^{G{}1−Π_{jεB[}1−pⱼ^{m1,B}(r_{m2,j)}]} (m-3)

and T_{m1,m2}^{G} is the time to get from m1 to m2.

### Constraints

The above optimization is solved under the following constraints, which are inserted in order to reduce the required computation power, so it can be done in real time.
1. The time to move from m1 to m2 should be less than a predetermined value.

X_{m1,m2}^{M}*T_{m1,m2}^{G}≦T₀^{G}
2. The risk to the GWO should be less than a predetermined value, i.e.

X_{m1,m2}^{M}*R_{m1,m2}^{G}≦Rₘₐₓ^{G}
3. At most one GWO is directed to move to a specific location, i.e.

X_{m1,m2}^{M}+X_{m3,m2}≦1
4. At most one destination is given to each GWO, i.e.

X_{m1,m2}^{M}+X_{m1,m3}^{M}≦1

### Move Model for Logistics Support

Logistics includes the combat support such as supply of ammunition, fuel and repair services and medical help. In this case we refer to the GWO needing the support as the demander and the supporting object as the supplier. Usually, if possible, the demander is directed to move to a location where he faces minimum risk, and the supplier is directed to that location.

We divide the logistic support to Logistic Classes, each of which contains all demanders and suppliers of the same service, i.e. Fuel Logistic Class, Ammunition Logistic Class, Medical Logistic Class, etc. Optimization is done for each Logistic Class which is comprised of Logistic Objects. We denote by DOⱼⁱ a demander object i belonging to Logistic Class j, and SOⱼ^{k} a supplier object belonging to the same Logistic Class—j.

### Decision Variables

The decision variables are of binary nature. Xᵢ^{k}=1 when supplier SOⱼ^{k} is assigned to move to demander DOⱼⁱ. Otherwise Xᵢ^{k}=0.

### Multi Objective Function

The Objective Function that we want to maximize is:

$${\sum }_{i = 1}^{\vert I \vert} {\sum }_{k = 1}^{\vert K \vert} {X}_{i}^{k} [ {C}_{i}^{D} ( 1 - {R}_{k}^{S} / {C}_{k}^{S} ) - {R}_{k}^{S} ] / {T}_{i}^{k} \qquad ( l \text{-} 1 )$$

where Cᵢ^{D} is the value of demander i, Cₖ^{S} is the value of supplier k, Rₖ^{S} is the risk expectation of supplier k and Tᵢ^{k} is the time for supplier k to get to demander i.

### Constraints

The above optimization is solved under the following constraints:
1. The time to move from m1 to m2 should be less than a predetermined value.

Xᵢ^{k}*Tᵢ^{k}≦T₀^{j}
2. The risk to the supplier should be less than a predetermined value, i.e.

Xᵢ^{k}*Rₖ^{S}≦R₀^{S}
3. At most one supplier is directed to move to a specific demander, i.e.

X_{m1,m2}^{S}+X_{m3,m2}^{S}≦1
4. Each supplier is directed to move at most to one specific demander, i.e.

X_{m1,m2}^{S}+X_{m1,m3}^{S}≦1

What is claimed is:

1. A system for optimal battle planning and for real time optimal battle management, comprising:
a plurality of manned and unmanned weapon objects, each of which is equipped with communication terminal;
a plurality of intelligence equipment that are capable of locating and identifying enemy forces and transmit the information;
a plurality of communication equipment that enables fast secure digital communication between the system components;
a plurality of data storage means that enables fast information update and retrieval;
a central computer system capable of processing in real time the information;
a computer program, executed on the central computer system, that prepares and transmits in real time a sequence of shoot and move commands to individual Weapon Objects and to Logistic Objects and continuously updates the command sequence;
a computer program, executed on the central computer system, that determines the optimal Weapon Classes and Weapon Objects to be assigned to a battle subject to user defined constraints.

2. A method for optimal assignment of Weapon Classes and Weapon Objects to a battle comprising:
defining the combat parameters of weapon and targets that may be involved in the battle;
determining optimal allocation of weapons to the mission;
checking the quality of the initial weapon assignment by simulating the battle;
performing incremental optimal allocation for the remaining enemy weapons and targets;
checking the updated quality of weapon allocation by simulating the battle;
repeating the last two steps till acceptable results are obtained.

3. The method according to claim 2, wherein optimal allocation and incremental optimal allocation are multi objective optimization designed to maximize the damage to the enemy while keeping to a minimum the risk which the friendly forces and targets are exposed to.

4. The method according to claim 3, wherein the multi objective optimization is solved by using linear programming technique, without the use of time consuming Mixed Integer Programming.

5. The method according to claim 2, wherein battle simulation is comprised of consecutive cycles of shoot simulation for the friendly and enemy forces followed by move simulation for both forces.

6. The method according to claim 5, wherein the shoot simulation and the move simulation comprises:
shoot optimization step where weapons are assigned targets to shoot at;
shoot execution;
move optimization step where a new location is assigned to each weapon object;
move execution.

7. The method according to claim 6, wherein shoot optimization and move optimization are multi objective optimization solved by using linear programming technique, without the use of time consuming Mixed Integer Programming

8. A method for optimal real time command and control of a battle comprising repeating the steps of:
gathering intelligence data on enemy forces and reports from the friendly forces;
simulating the battle;
assigning optimal shoot and move command sequence to the friendly weapon object;
performing optimal incremental allocation of forces if required.

9. The method according to claim 8, wherein battle simulation is comprised of consecutive cycles of shoot simulation for the friendly and enemy forces followed by move simulation for both forces.

10. The method according to claim 9, wherein the shoot simulation and the move simulation comprises:
shoot optimization step where weapons are assigned targets to shoot at;
shoot execution;
move optimization step where a new location is assigned to each weapon object;
move execution.

11. The method according to claim 9, wherein shoot optimization and move optimization are multi objective optimization solved by using linear programming technique, without the use of time consuming Mixed Integer Programming.

12. The method according to claim 8, wherein optimal allocation and incremental optimal allocation are multi objective optimization designed to maximize the damage to the enemy while keeping to a minimum the risk which the friendly forces and targets are exposed to.

13. The method according to claim 12, wherein the multi objective optimization is solved by using linear programming technique, without the use of time consuming Mixed Integer Programming.
